(19) United States
(12) Patent Application Publication
(10) Pub. No.: US 2018/0229278 A1
(43) Pub. Date: Aug. 16, 2018

(54) REFINERY OXYGEN HOSE CLEANING APPARATUS AND METHOD

(71) Applicant: Total Safety U.S., Inc., Houston, TX (US)

(72) Inventors: Dave Myslenski, Houston, TX (US); Bart Peetermans, Houston, TX (US)

(21) Appl. No.: 15/757,626

(22) PCT Filed: Jul. 20, 2016
(86) PCT No.: PCT/US2016/043086

§ 371 Date: Mar. 5, 2018

Related U.S. Application Data
(60) Provisional application No. 62/197,955, filed on Jul. 28, 2015.

(51) Int. Cl. B08B 9/023; B08B 3/02

(52) U.S. Cl. CPC B08B 9/023; B08B 1/002; B08B 3/022

(57) ABSTRACT

A cleaning apparatus for a flexible hose has a housing, a first reel and a second reel disposed in the housing, at least one of which is operable to spool the flexible hose, and a cleaning box disposed between the first reel and the second reel that cleans an outside surface of the flexible hose.

### BACKGROUND

### Field of the Disclosure

The present invention generally relates to apparatuses and methods for cleaning an oxygen hose. In particular, the present invention relates to apparatuses and method for cleaning an oxygen hose employed in a refinery.

### Related Art

Referring to FIG. 1, refineries for refining crude oil often have equipment such as safety and/or monitoring equipment 17 in an enclosed space 1. The enclosed space 1 may have noxious fumes that require employees 11 working on or with the safety and/or monitoring equipment 17 to wear a mask 13 connected to an oxygen tank 15 via a flexible hose 10, so that clean air can be supplied to the employee 11. Alternatively, the flexible hose 10 may instead be vented outside to supply clean outside air to the employee 11.

The flexible hose 10 may pick up oil, dirt, soot, dust, and other foreign particles, which may degrade the flexibility of the flexible hose 10, and/or may damage the flexible hose 10.

### SUMMARY

According to one or more embodiments of the present invention, a cleaning apparatus for a flexible hose comprises a housing, a first reel and a second reel disposed in the housing, at least one of which is operable to spool the flexible hose, and a cleaning box disposed between the first reel and the second reel that cleans an outside surface of the flexible hose.

According to one or more embodiments of the present invention, the housing comprises an opening through which the flexible hose is inserted into the housing.

According to one or more embodiments of the present invention, the second reel is disposed on a shaft that is actuated to rotate.

According to one or more embodiments of the present invention, the cleaning apparatus comprises a fan that provides air to the flexible hose.

According to one or more embodiments of the present invention, the cleaning apparatus comprises a RFID reader that reads an RFID tag disposed on the flexible hose.

According to one or more embodiments of the present invention, the cleaning apparatus comprises a pneumatic inlet that attaches to an end of the flexible hose to pressurize an inside thereof.

According to one or more embodiments of the present invention, the cleaning box comprises at least one cleaning water nozzle that sprays the flexible hose passing through the cleaning box.

According to one or more embodiments of the present invention, the cleaning box comprises a brush cylinder having brushes that brush an outer surface of the flexible hose passing through the cleaning box.

According to one or more embodiments of the present invention, the cleaning apparatus comprises a drying element disposed in the housing outside of the cleaning box that removes water from an outer surface of the flexible hose.

According to one or more embodiments of the present invention, a cleaning method for a flexible hose comprises disposing the flexible hose in a housing, passing the flexible hose through a cleaning box, and spooling the flexible hose on a second reel.

According to one or more embodiments of the present invention, disposing the flexible hose in the housing comprises placing a first reel having the flexible hose spooled therearound within the housing, the cleaning box is disposed between the first reel and the second reel, and the flexible hose is transferred from the first reel to the second reel through the cleaning box.

According to one or more embodiments of the present invention, disposing the flexible hose in the housing comprises feeding the flexible hose into the housing through an opening in the housing.

According to one or more embodiments of the present invention, the second reel is actuated to rotate, such that the flexible hose is pulled through the cleaning box.

According to one or more embodiments of the present invention, the cleaning method comprises removing the second reel having the flexible hose spooled therearound.

According to one or more embodiments of the present invention, the cleaning method comprises drying the flexible hose with a fan or a drying element after the flexible hose exits the cleaning box.

According to one or more embodiments of the present invention, the cleaning method comprises reading information regarding the flexible hose from an RFID tag disposed on the flexible hose.

According to one or more embodiments of the present invention, passing the flexible hose through the cleaning box comprises spraying cleaning water onto the flexible hose within the cleaning box.

According to one or more embodiments of the present invention, passing the flexible hose through the cleaning box comprises passing the flexible hose through a cleaning water pool.

According to one or more embodiments of the present invention, passing the flexible hose through the cleaning box comprises passing the flexible hose through a brush cylinder having brushes disposed on an inside circumference thereof.

According to one or more embodiments of the present invention, the cleaning method comprises pressurizing an inside of the flexible hose to check for air leaks.

Other aspects and advantages of the disclosure will be apparent from the following description and the appended claims.

### BRIEF DESCRIPTION OF DRAWINGS

FIG. 1 is a schematic diagram showing an enclosed space at a refinery having a flexible hose for supplying oxygen.

FIG. 2 shows a flexible hose cleaning apparatus with empty reels before the flexible hose is loaded, according to one or more embodiments of the present invention.

FIG. 3 shows a flexible hose cleaning apparatus on which a third reel having a flexible hose wrapped therearound is loaded on a first position, according to one or more embodiments of the present invention.

FIG. 4 shows a flexible hose cleaning apparatus in which the flexible hose is being transferred from a third reel to a second reel through a cleaning box, according to one or more embodiments of the present invention.

FIG. 5 shows a flexible hose cleaning apparatus in which the flexible hose is fully transferred to the second reel, according to one or more embodiments of the present invention.

FIG. 6 shows a flexible hose cleaning apparatus on which a flexible hose is fed through an opening and atop a first reel, according to one or more embodiments of the present invention.

FIG. 7 shows a flexible hose cleaning apparatus on which the flexible hose is fed through the opening and atop the first reel to a second reel through a cleaning box, according to one or more embodiments of the present invention.

FIG. 8 shows a flexible hose cleaning apparatus on which the flexible hose is nearly fully transferred to the second reel, according to one or more embodiments of the present invention.

FIG. 9 shows a flexible hose cleaning apparatus having fans disposed above the portion of the flexible hose between the first and second reels, according to one or more embodiments of the present invention.

FIG. 10 shows a flexible hose cleaning apparatus having fans disposed above and to outer sides of the first and second reels, according to one or more embodiments of the present invention.

FIG. 11 shows a flexible hose cleaning apparatus having limiters for stopping the ends of the flexible hose, according to one or more embodiments of the present invention.

FIG. 12 shows a flexible hose cleaning apparatus having RFID readers and/or RFID writers that reads or writes RFID tags disposed on the flexible hose, according to one or more embodiments of the present invention.

FIG. 13 shows a flexible hose cleaning apparatus having a pneumatic inlet that attaches to the flexible hose and a pressure pump mechanism, according to one or more embodiments of the present invention.

FIG. 14 shows a flexible hose cleaning apparatus having drying elements, according to one or more embodiments of the present invention.

FIG. 15 shows a schematic view of a cleaning box according to one or more embodiments of the present invention.

FIG. 16 shows a schematic view of a cleaning box according to one or more embodiments of the present invention.

FIG. 17 shows a schematic view of a cleaning box according to one or more embodiments of the present invention.

FIG. 18 shows a schematic view of a cleaning box according to one or more embodiments of the present invention.

FIG. 19 shows a cross-section view of a brush cylinder according to one or more embodiments of the present invention.

FIG. 20 shows a top view of a flexible hose cleaning apparatus according to one or more embodiments of the present invention.

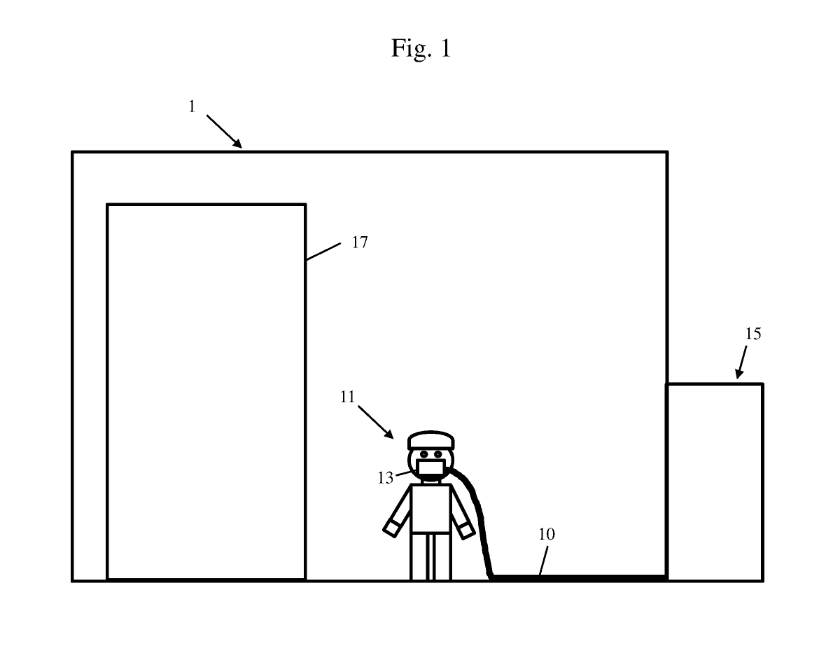

### DETAILED DESCRIPTION

Embodiments of the present disclosure will be described below with reference to the drawings. In embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid obscuring the disclosure.

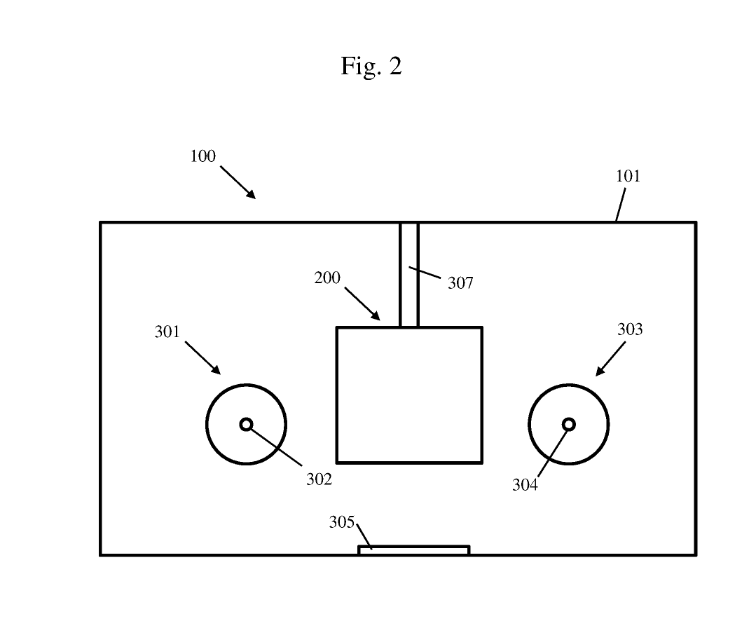

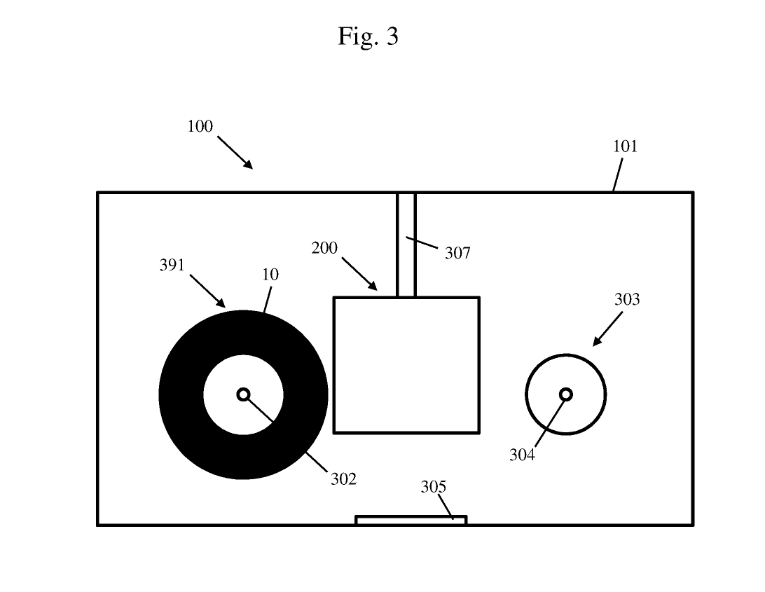

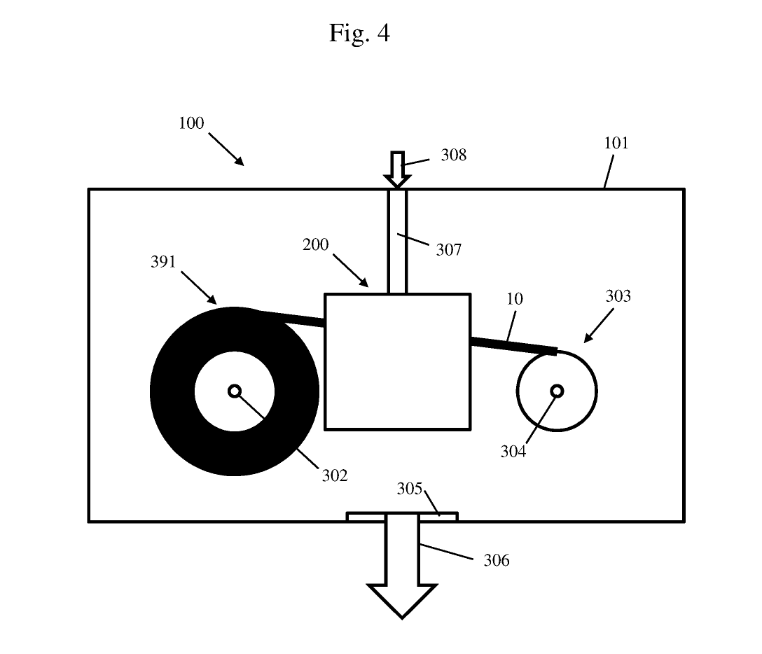

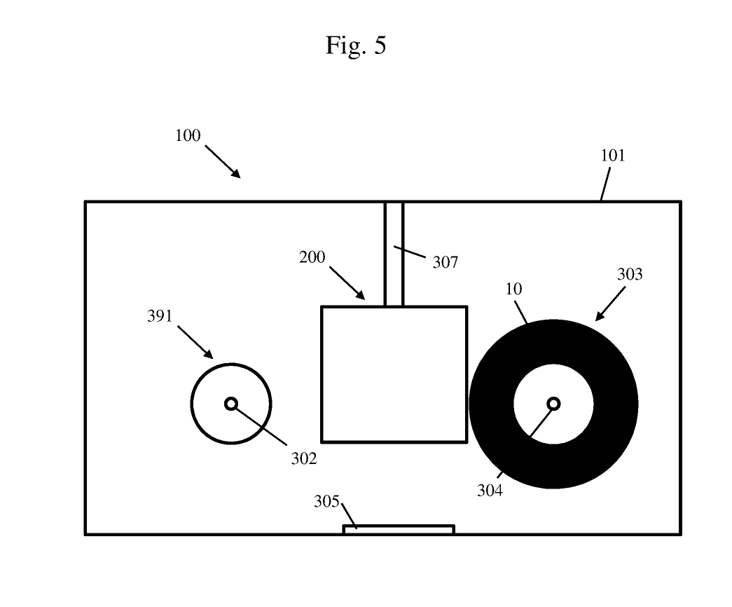

FIGS. 2-5 show a flexible hose cleaning apparatus 100 according to one or more embodiments of the present invention. Specifically, FIG. 2 shows a flexible hose cleaning apparatus 100 with empty reels 301, 303 before the flexible hose 10 is loaded thereon, according to one or more embodiments of the present invention, FIG. 3 shows a flexible hose cleaning apparatus 100 on which a third reel 391 having a flexible hose 10 wrapped therearound is loaded at a first position, according to one or more embodiments of the present invention, FIG. 4 shows a flexible hose cleaning apparatus 100 in which the flexible hose 10 is being transferred from a third reel 391 to a second reel 303 through a cleaning box 200, according to one or more embodiments of the present invention, and FIG. 5 shows a flexible hose cleaning apparatus 100 in which the flexible hose 10 is fully transferred to the second reel 303, according to one or more embodiments of the present invention.

As shown in FIG. 2, a flexible hose cleaning apparatus 100 is formed of a waterproof housing 101, and includes a cleaning box 200, a water inlet 307 for the cleaning box 200, and a water outlet 305. In the drawings, the front cover of the waterproof housing 101 has been removed to show the inner components thereof. Additionally, according to one or more embodiments of the present invention, the front cover is removed to load a loaded third reel 391. However, during the cleaning operation of the flexible hose cleaning apparatus 100, the front cover will be placed back on the waterproof housing 101. Initially, an empty first reel 301 is disposed at a first position on a left side of the cleaning box 200, and an empty second reel 303 is disposed on a right side of the cleaning box 200. The first reel 301 is loaded on a first shaft 302, and the second reel 303 is loaded on a second shaft 304. According to one or more embodiments of the present invention, the first and second shafts 302, 304 are rotatable, and are rigidly attached to the first and second reels 301, 303. Alternatively, the first shaft 302 may not be rotatable, and the first reel 301 may be rotatable with respect the first shaft 302.

As shown in FIG. 3, the empty first reel 301 is removed, and a loaded third reel 391, having a dirty flexible hose 10 wrapped therearound, is loaded on the first shaft at the first position. Alternatively, according to one or more embodiments of the present invention, the flexible hose cleaning apparatus 100 may not have an empty reel disposed at the first position before the loaded third reel 391 is loaded. According to one or more embodiments of the present invention, the first shaft 302 is rotatable, and is rigidly attached to the third reel 391. Alternatively, the first shaft 302 may not be rotatable, and the third reel 391 may be rotatable with respect the first shaft 302.

As shown in FIG. 4, one end of the flexible hose 10 is attached to the empty second reel 303. According to one or more embodiments of the present invention, the end of the flexible hose 10 may be manually pulled through the cleaning box 200 and attached to the empty second reel 303. Alternatively, according to one or more embodiments of the present invention, a dummy hose attached to the second reel 303 may be fed through the cleaning box 200 from the right side, and attached to the end of the flexible hose 10 on the left side of the cleaning box 200.

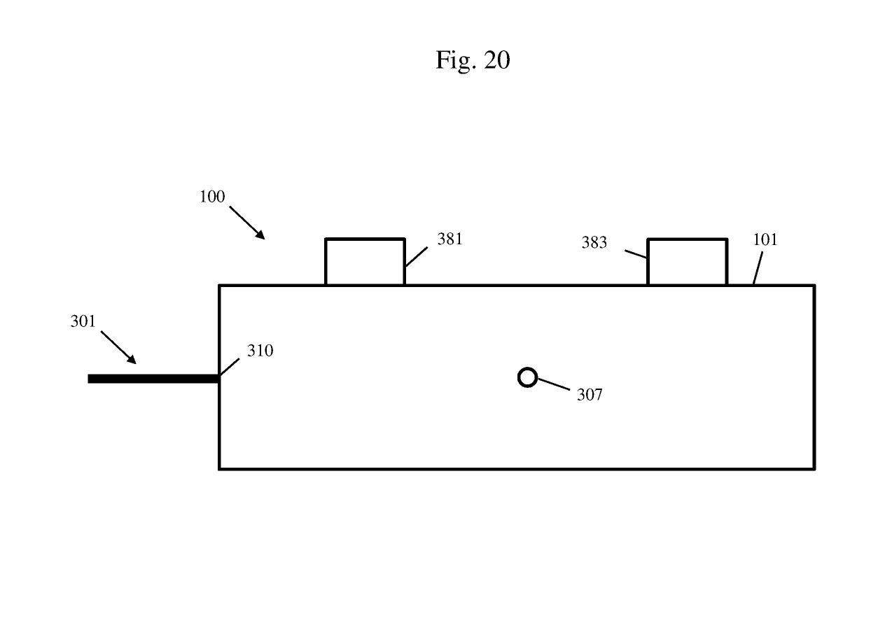

As shown in FIG. 20, which shows a top view of a flexible hose cleaning apparatus 100 according to one or more embodiments of the present invention, actuators 381, 383 may be disposed at the back of the waterproof housing 101, at locations corresponding to the location of the first and second shafts 302, 304. According to one or more embodiments of the present invention, the actuators 381, 383 may be electric motors.

According to one or more embodiments, an actuator 383 rotates the second shaft 304 clockwise, and the tension on the flexible hose 10 caused by the rotating second reel 303 pulls the flexible hose 10 onto the second reel 303 from the third reel 391.

Alternatively, according to one or more embodiments of the present invention, the first shaft 302 and the second shaft 304 may be concurrently rotated clockwise by an actuator or actuators 381, 383, so that the flexible hose 10 is fed onto the second reel 303 from the third reel 391. According to one or more embodiments of the present invention, the diameter of the third and second reels 391, 303 with the flexible hose 10 therearound are continually monitored, and the rotation speed of the first and second shafts 302, 304 are continually adjusted accordingly, so that the linear velocity of the flexible hose 10 exiting the third reel 391 matches the linear velocity of the flexible hose 10 entering the second reel 303.

According to one or more embodiments of the present invention, cleaning water 308 is fed into the cleaning box 200 through the water inlet 307, and the dirty water 306 is removed from the flexible hose cleaning apparatus 100 through the water outlet 305. According to one or more embodiments of the present invention, the cleaning water 308 may be normal water. Alternatively, according to one or more embodiments of the present invention, the cleaning water 308 may include chemicals to facilitate cleaning of the flexible hose 10. As the flexible hose 10 passes through the cleaning box 200, an outer surface of the flexible hose 10 is cleaned, so that the flexible hose 10 is clean as it is fed onto the second reel 303.

As shown in FIG. 5, the entire flexible hose 10, cleaned by the cleaning box 200, may be fully transferred to the second reel 303. The second reel 303 having the clean flexible hose 10 may now be removed and replaced with another empty reel or, alternatively, the clean flexible hose 10 may be taken off of the second reel 303 and the empty 303 may be placed back onto the second shaft 304.

However, a single pass through the cleaning box 200 may not be sufficient to fully clean the dirty flexible hose 10. In such a case, the flexible hose 10 may be transferred from the second reel 303 back to the third reel 391 by attaching the other end of the flexible hose 10 to the third reel 391, and rotating the first shaft 302 and/or the second shaft 304 in a counterclockwise direction, such that the flexible hose 10 is fed back through the cleaning box 200 in the opposite direction. The second run of the flexible hose 10 may be similar to the above-described process, but only in the opposite direction and, therefore, will not be described in detail. According to one or more embodiments of the present invention, the process can be repeated as many times as desired until the flexible hose 10 is sufficiently clean.

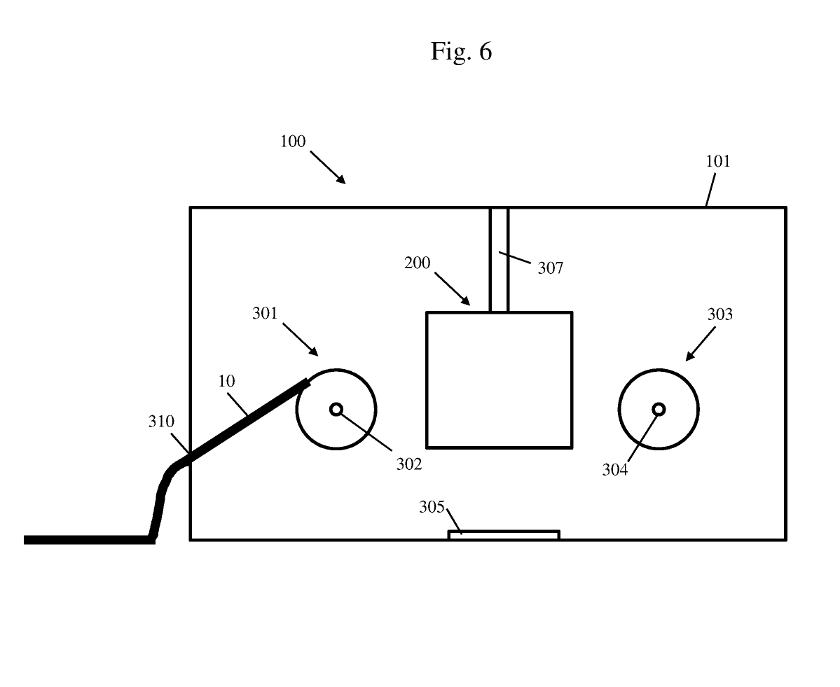

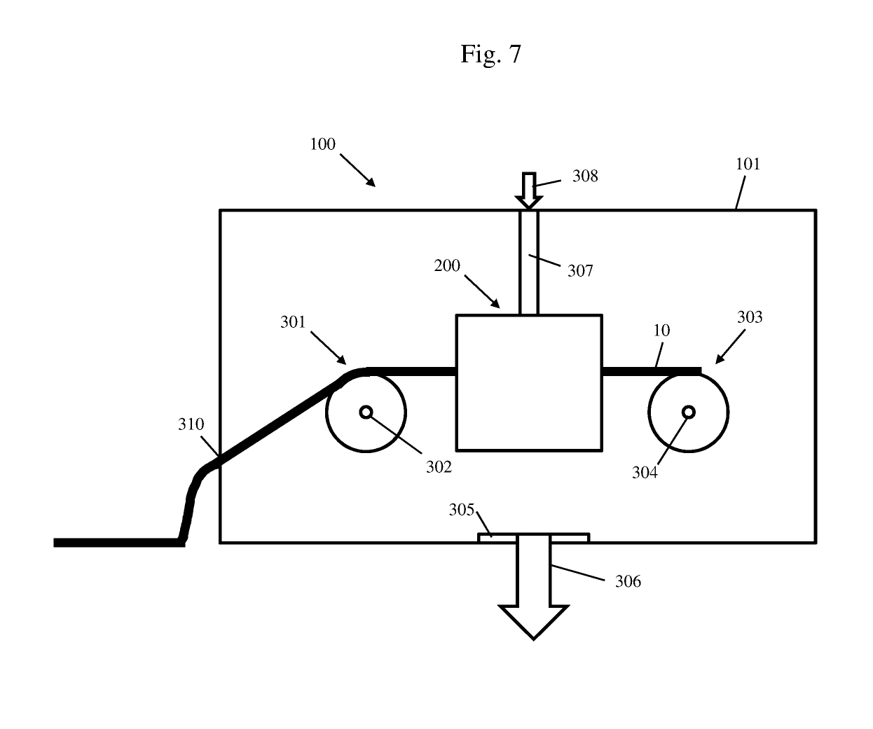

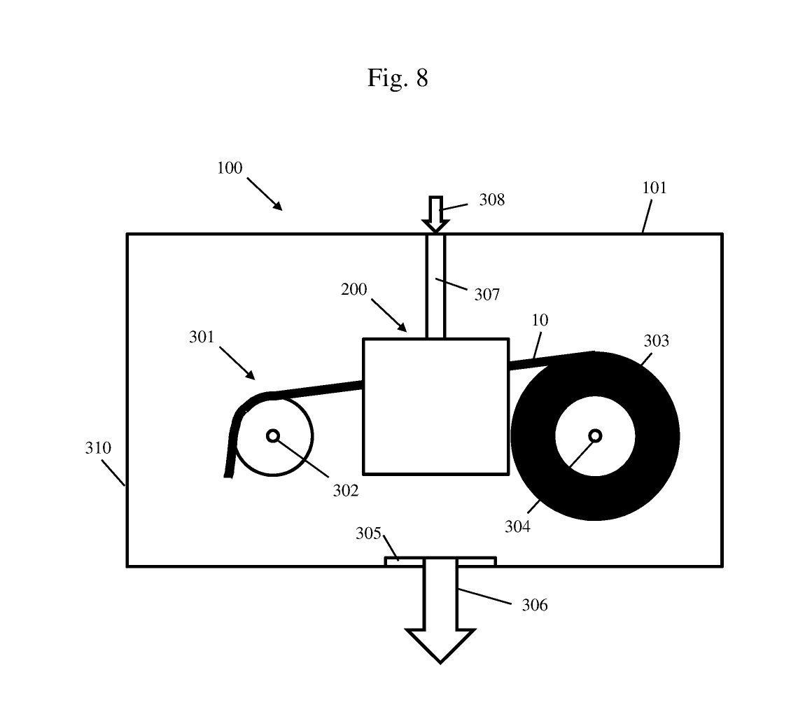

FIGS. 6-8 show a flexible hose cleaning apparatus 100 according to one or more embodiments of the present invention. Specifically, FIG. 6 shows a flexible hose cleaning apparatus 100 on which a flexible hose 10 is fed through an opening 310 and atop a first reel 301, according to one or more embodiments of the present invention, FIGS. 7 and 8 show the flexible hose 10 being transferred from the first reel 301 to the second reel 303 through a cleaning box 200, according to one or more embodiments of the present invention.

As shown in FIG. 6, a flexible hose cleaning apparatus 100 according to one or more embodiments of the present invention is similar to that shown in FIGS. 2-5, and is formed of a waterproof housing 101, and includes a cleaning box 200, a water inlet 307 for the cleaning box 200, and a water outlet 305. However, the flexible hose cleaning apparatus shown in FIGS. 6-8 also includes an opening 310 through which the flexible hose 10 is fed into the flexible hose cleaning apparatus 100 and atop the empty first reel 301. The process shown in FIGS. 6-8 does not require the empty first reel 301 to be replaced with a loaded third reel 391, as was the case with the process shown in FIG. 2-5. Instead, the first reel 301 is employed to help transfer the flexible hose 10 being fed into the opening 310 to the second reel 303.

As shown in FIG. 7, the flexible hose 10 is attached to the empty second reel 303. According to one or more embodiments of the present invention, the end of the flexible hose 10 may be manually pulled through the cleaning box 200 and attached to the empty second reel 303. Alternatively, according to one or more embodiments of the present invention, a dummy hose attached to the second reel 303 may be fed through the cleaning box 200 from the right side, and attached to the end of the flexible hose 10 on the left side of the cleaning box 200.

According to one or more embodiments, an actuator 383 rotates the second shaft 304 clockwise, and the tension on the flexible hose 10 caused by the rotating second reel 303 pulls the flexible hose 10 onto the second reel 303 from opening 310 through the first reel 301.

Alternatively, according to one or more embodiments of the present invention, the first shaft 302 and the second shaft 304 may be concurrently rotated clockwise by an actuator or actuators 381, 383, so that the flexible hose 10 is fed onto the second reel 303 from the first reel 301. According to one or more embodiments of the present invention, the diameter of the second reel 303 with the flexible hose 10 therearound is continually monitored, and the rotation speed of the first and second shafts 302, 304 are continually adjusted accordingly, so that the linear velocity of the flexible hose 10 exiting the first reel 301 matches the linear velocity of the flexible hose 10 entering the second reel 303.

According to one or more embodiments of the present invention, cleaning water 308 is fed into the cleaning box 200 through the water inlet 307, and the dirty water 306 is removed from the flexible hose cleaning apparatus 100 through the water outlet 305. According to one or more embodiments of the present invention, the cleaning water 308 may be normal water. Alternatively, according to one or more embodiments of the present invention, the cleaning water 308 may include chemicals to facilitate cleaning of the flexible hose 10. As the flexible hose 10 passes through the cleaning box 200, an outer surface of the flexible hose 10 is cleaned, so that the flexible hose 10 is clean as it is fed onto the second reel 303.

As shown in FIG. 8, the flexible hose 10 is spooled around the second reel 303 after exiting the cleaning device 200. Once the entirety of the flexible hose 10 is spooled around the second reel 303, the flexible hose cleaning apparatus 100 will resemble that shown in FIG. 5, except that the flexible hose cleaning apparatus 100 will have an empty first reel 301 in place of the third reel 391, and have the opening 310. The second reel 303 having the clean flexible hose 10 may now be removed, and replaced with another empty reel or, alternatively, the clean flexible hose 10 may be taken off of the second reel 303, and the empty 303 may be placed back onto the second shaft 304.

However, a single pass through the cleaning box 200 may not be sufficient to fully clean the dirty flexible hose 10. In such a case, the flexible hose 10 may be transferred from the second reel 303 onto the first reel 301 by attaching the other end of the flexible hose 10 to the first reel 301, and rotating the first shaft 302 and/or the second shaft 304 in a counterclockwise direction, such that the flexible hose 10 is fed back through the cleaning box 200 in the opposite direction. The second run of the flexible hose 10 may be similar to the process shown in FIGS. 2-5, but only in the opposite direction and, therefore, will not be described in detail. According to one or more embodiments of the present invention, the process can be repeated as many times as desired until the flexible hose 10 is sufficiently clean.

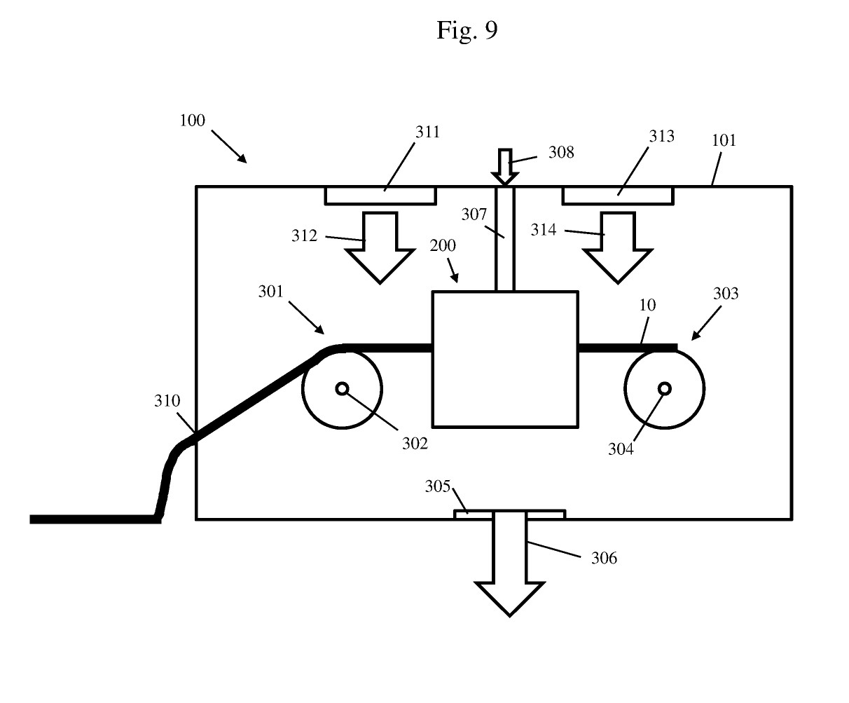

According to one or more embodiments of the present invention, as shown in FIG. 9, a flexible hose cleaning apparatus 100 may also include first and second fans 311, 313 disposed above the portion of the flexible hose 10 between the first and second reels 301, 303. When the flexible hose 10 is being transferred to the second reel 303, the flexible hose 10 may be wet as it exits the cleaning box 200 in the left-to-right direction. The second fan 313 provides drying air 314 to dry the flexible hose 10 as it exits the cleaning box 200 and is spooled around the second reel 303.

In the case that a single pass through the cleaning box 200 is not sufficient to fully clean the dirty flexible hose 10, and the flexible hose 10 is transferred from the second reel 303 onto the first reel 301 in the right-to-left direction, the first fan 311 provides drying air 312 to dry the flexible hose 10 as it exits the cleaning box 200 and is spooled around the first reel 301.

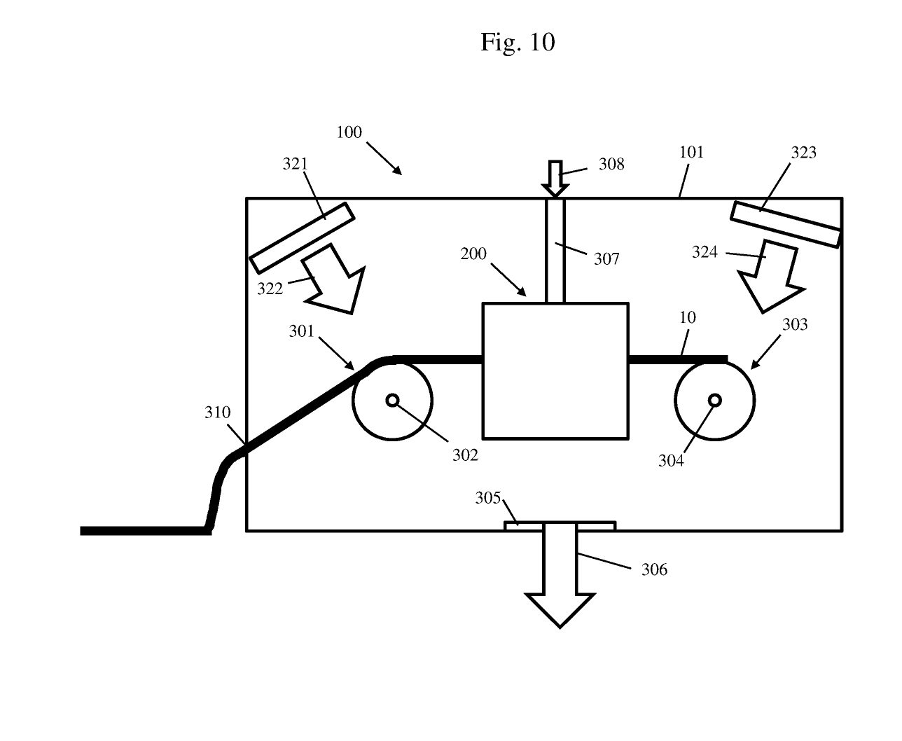

Alternatively, according to one or more embodiments of the present invention, as shown in FIG. 10, first and second fans 321, 323 may be disposed above and to the outer side of the first and second reels 301, 303. When the flexible hose 10 is being transferred to the second reel 303, the second fan 323 provides drying air 324 in a direction of the second reel 303 to dry the flexible hose 10 as it is spooled around the second reel 303.

In the case a single pass through the cleaning box 200 is not sufficient to fully clean the dirty flexible hose 10, and the flexible hose 10 is transferred from the second reel 303 onto the first reel 301 in the right-to-left direction, the first fan 321 provides drying air 322 in a direction of the first reel 301 to dry the flexible hose 10 as it is spooled around the first reel 301.

According to one or more embodiments of the present invention, as shown in FIG. 11, a flexible hose cleaning apparatus 100 may have first and second limiters 331, 333 for stopping the ends of the flexible hose 10. That is, if the flexible hose 10 is being transferred to the second reel 303 in the left-to-right direction, the first limiter 331 may catch the left end of the flexible hose 10. If the flexible hose 10 is being transferred to the first reel 301 in the right-to-left direction, the second limiter 333 may catch the right end of the flexible hose 10.

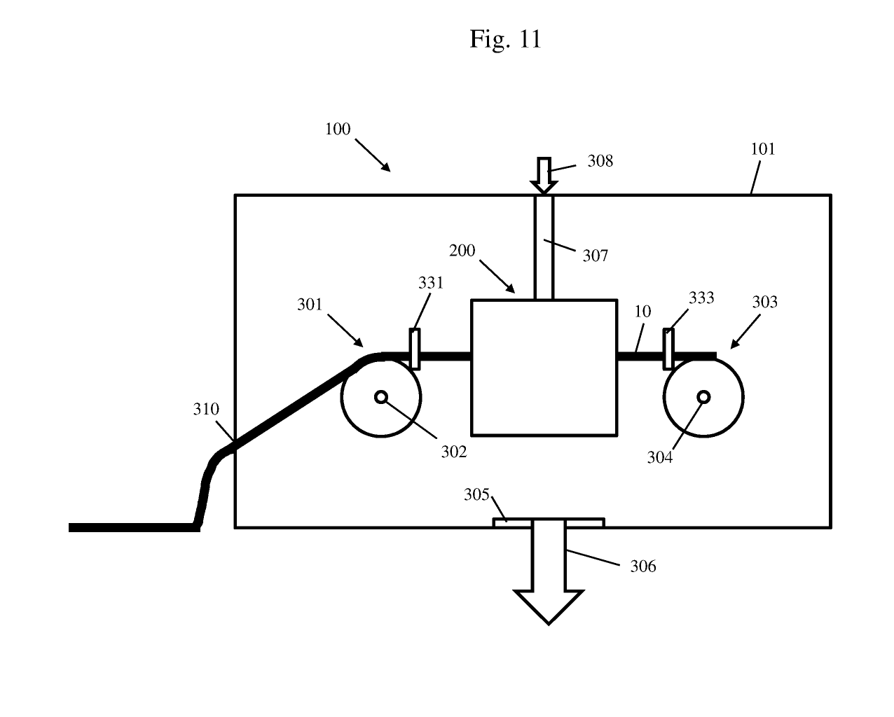

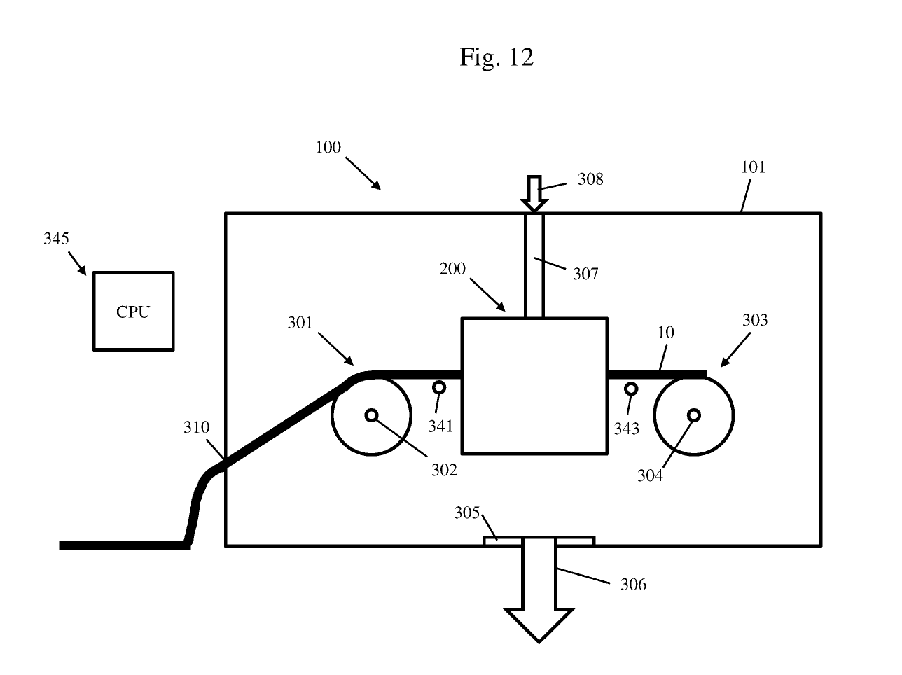

According to one or more embodiments of the present invention, as shown in FIG. 12, a flexible hose cleaning apparatus 100 may include RFID readers and/or RFID writers 341, 343 that read or write RFID tags disposed on the flexible hose 10 via a CPU 345 that is paired via wires or wirelessly with the RFID readers and/or RFID writers 341, 343. According to one or more embodiments of the present invention, the RFID readers and/or RFID writers 341, 343 may read identification information identifying the specific hose 10 being cleaned and send the information to the CPU 345, so that the CPU 345 may store information on when and how many times the specific flexible hose 10 has been cleaned. Furthermore, the CPU 345 may be paired with the pressure sensor, so any leakage in the specific flexible hose 10 may be recorded in the CPU 345 along with the identification information. According to one or more embodiments of the present invention, the CPU 345 may write the information on when and how many times the specific flexible hose 10 has been cleaned, as well as any leakage information, onto the RFID readers and/or RFID writers 341, 343.

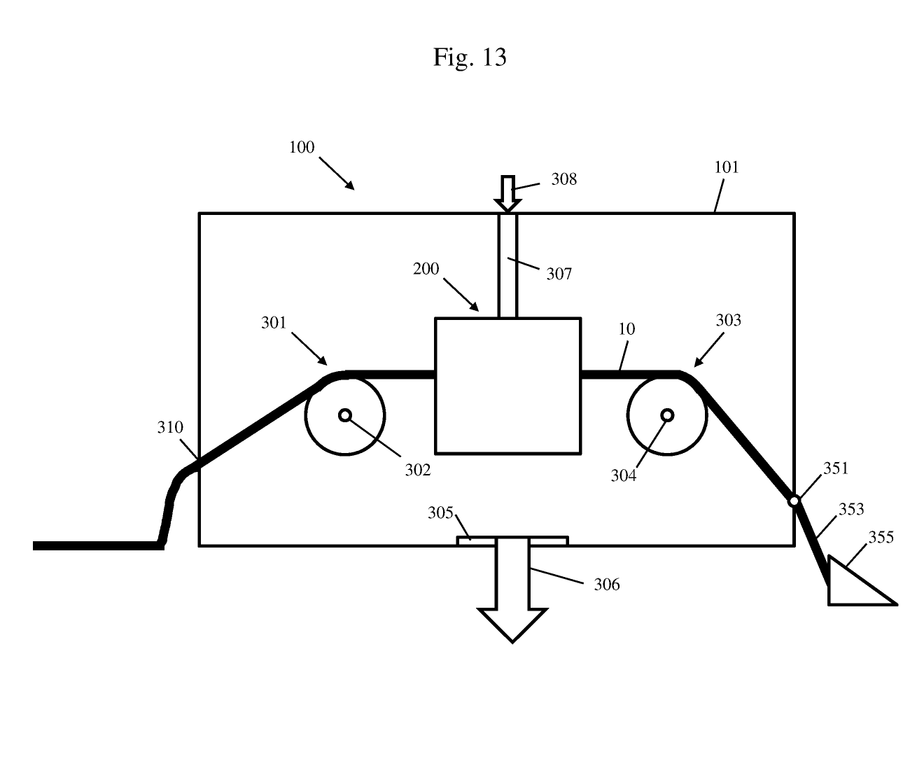

According to one or more embodiments of the present invention, as shown in FIG. 13, a flexible hose cleaning apparatus may also include a pneumatic inlet 351 that attaches to the flexible hose 10. The pneumatic inlet 351 may be connected to a pressure pump mechanism 355 via a pressure line 353. The pressure pump mechanism 355 is operated to pump air into the flexible hose 10 to pressurize the inside of the flexible hose, in order to check for leaks. According to one or more embodiments of the present invention, the pressure pump mechanism 355 may be a foot pedal. According to one or more embodiments of the present invention, the end of the flexible hose 10 that is not attached to the pneumatic inlet 351 may be connected to a pressure sensor disposed in the flexible hose cleaning apparatus 100.

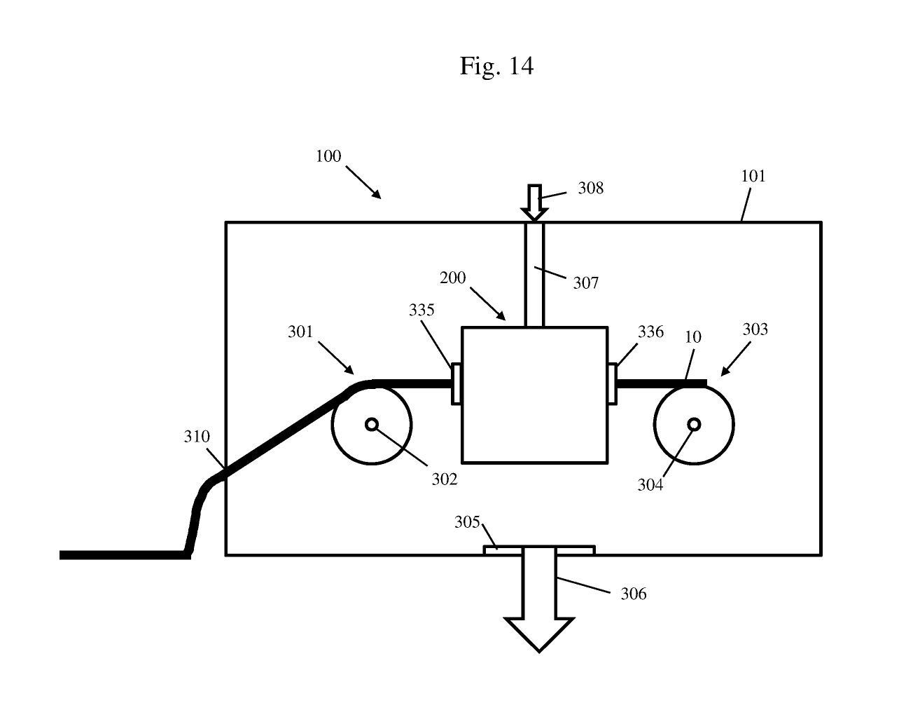

According to one or more embodiments of the present invention, as shown in FIG. 14, a flexible hose cleaning apparatus may include first and second drying elements 335, 336. As the wet flexible hose 10 exits the cleaning box 200, the flexible hose 10 passes through the first or second drying elements 335, 336, to dry the flexible hose 10. According to one or more embodiments of the present invention, the first and second drying elements 335, 336, may be squeegees.

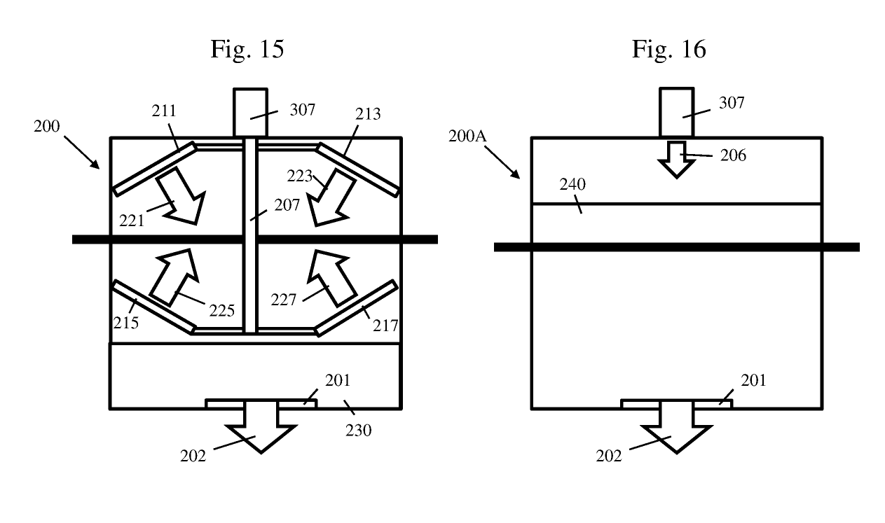

According to one or more embodiments of the present invention, as shown in FIG. 15, a cleaning box 200 may include first and second nozzles 211, 213 disposed above the flexible hose 10, and third and fourth nozzles 215, 217 disposed below the flexible hose 10. As the flexible hose 10 passes through the cleaning box 200, cleaning water from the water inlet 307 is distributed to the first, second, third, and fourth nozzles 211, 213, 215, 217 via water lines 207, the first, second, third, and fourth nozzles 211, 213, 215, 217 spray cleaning water jets 221, 223, 215, 227 at the flexible hose 10 to clean the outer surface of the flexible hose 10. The sprayed cleaning water is collected at the bottom of the cleaning box 200 to form a pool 230. A cleaning water drain 201 is disposed at the bottom of the cleaning box 200, through which the dirty cleaning water 202 is drained therefrom.

According to one or more embodiments of the present invention, as shown in FIG. 16, a cleaning box 200A may include a cleaning water pool 240. Cleaning water 206 is fed into the cleaning water pool 240 from the cleaning water inlet 307. As the flexible hose 10 passes through the cleaning box 200A, the flexible hose 10 is passed through the cleaning water pool 240 to clean the outer surface of the flexible hose 10. A cleaning water drain 201 is disposed at the bottom of the cleaning box 200A, through which the dirty cleaning water 202 is drained. The volumetric flowrate of the cleaning water 206 entering the cleaning box 200A and/or the volumetric flowrate of the dirty cleaning water 202 exiting the cleaning box 200A may be controlled to be equal, so that the level of the cleaning water pool 240 stays constant.

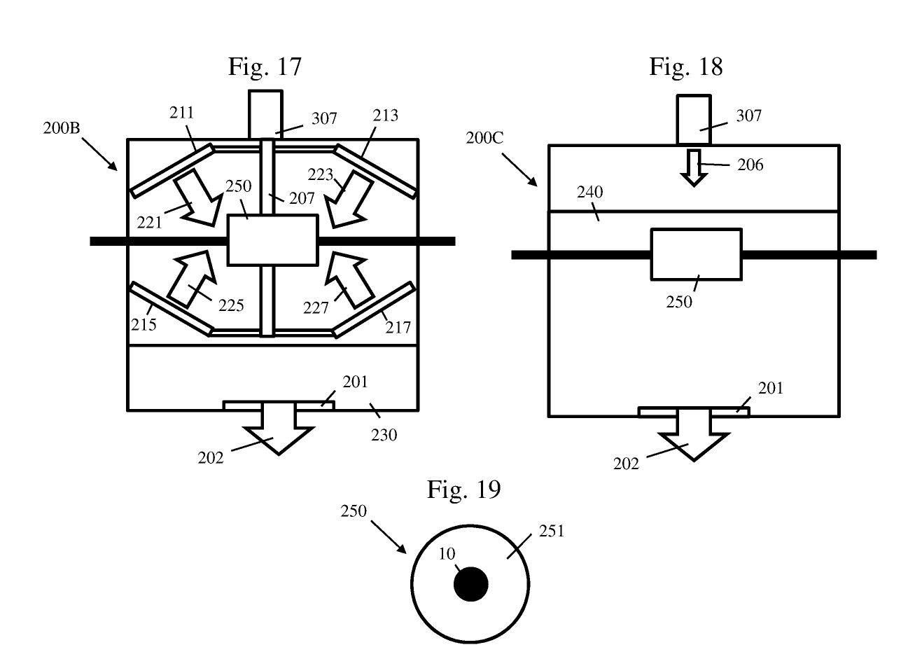

According to one or more embodiments of the present invention, as shown in FIG. 17, a cleaning box 200B may include first and second nozzles 211, 213 disposed above the flexible hose 10, and third and fourth nozzles 215, 217 disposed below the flexible hose 10. As the flexible hose 10 passes through the cleaning box 200, cleaning water from the water inlet 307 is distributed to the first, second, third, and fourth nozzles 211, 213, 215, 217 via water lines 207, the first, second, third, and fourth nozzles 211, 213, 215, 217 spray cleaning water jets 221, 223, 215, 227 at the flexible hose 10 to clean the outer surface of the flexible hose 10. The sprayed cleaning water is collected at the bottom of the cleaning box 200 to form a pool 230. A cleaning water drain 201 is disposed at the bottom of the cleaning box 200, through which the dirty cleaning water 202 is drained therefrom.

FIG. 17 shows a cleaning box 200B according to one or more embodiments of the present invention, and FIG. 18 shows a cleaning box 200C according to one or more embodiments of the present invention. The cleaning box 200B is similar to the cleaning box 200 shown in FIG. 15, and the cleaning box 200C is similar to the cleaning box 200A shown in FIG. 16, but further includes a brush cylinder 250. The brush cylinder 250 is attached to the inner wall of the cleaning box 200B, 200C.

As shown in FIG. 19, the brush cylinder 250 has replaceable brushes 251 disposed on an inner circumference thereof. As shown in FIGS. 17-19, the flexible hose 10 is passed through the brush cylinder 250, and the replaceable brushes 251 brush and clean the outer surface of the flexible hose 10.

According to one or more embodiments of the present invention, the dirty flexible hose 10 may be pre-soaped before entering the flexible hose cleaning apparatus 100, and the cleaning box 200 cleans the pre-soaped flexible hose 10.

One or more embodiments of the present invention may include an actuator on/off switch that turns the actuators 381, 383 running the first and/or second shafts 302, 304 on and off, a water on/off switch that turns the water inlet 307 on/off and an emergency shutoff switch that stops the actuators 381, 383 running the first and/or second shafts 302, 304 and/or the water inlet 307.

While a limited number of embodiments are described above, those skilled in the art, having benefit of this disclosure, will appreciate that other embodiments can be devised which do not depart from the scope of the disclosure as disclosed herein. Accordingly, the scope of the disclosure should be limited only by the attached claims.

What is claimed is:

1. A cleaning apparatus for a flexible hose, comprising:
a housing;
a first reel and a second reel disposed in the housing, at least one of which is operable to spool the flexible hose;
a cleaning box disposed between the first reel and the second reel that cleans an outside surface of the flexible hose.

2. The cleaning apparatus according to claim 1,
wherein the housing comprises an opening through which the flexible hose is inserted into the housing.

3. The cleaning apparatus according to claim 1,
wherein the second reel is disposed on a shaft that is actuated to rotate.

4. The cleaning apparatus according to claim 1, further comprising:
a fan that provides air to the flexible hose.

5. The cleaning apparatus according to claim 1, further comprising:
a RFID reader that reads an RFID tag disposed on the flexible hose.

6. The cleaning apparatus according to claim 1,
further comprising a pneumatic inlet that attaches to an end of the flexible hose to pressurize an inside thereof.

7. The cleaning apparatus according to claim 1,
wherein the cleaning box comprises at least one cleaning water nozzle that sprays the flexible hose passing through the cleaning box.

8. The cleaning apparatus according to claim 1,
wherein the cleaning box comprises a brush cylinder having brushes that brush an outer surface of the flexible hose passing through the cleaning box.

9. The cleaning apparatus according to claim 1, further comprising:
a drying element disposed in the housing outside of the cleaning box that removes water from an outer surface of the flexible hose.

10. A cleaning method for a flexible hose, comprising:
disposing the flexible hose in a housing;
passing the flexible hose through a cleaning box; and
spooling the flexible hose on a second reel.

11. The cleaning method according to claim 10,
wherein the disposing the flexible hose in the housing comprises placing a first reel having the flexible hose spooled therearound within the housing,
wherein the cleaning box is disposed between the first reel and the second reel, and
wherein the flexible hose is transferred from the first reel to the second reel through the cleaning box.

12. The cleaning method according to claim 10,
wherein the disposing the flexible hose in the housing comprises feeding the flexible hose into the housing through an opening in the housing.

13. The cleaning method according to claim 10,
wherein the second reel is actuated to rotate, such that the flexible hose is pulled through the cleaning box.

14. The cleaning method according to claim 10, further comprising:
removing the second reel having the flexible hose spooled therearound.

15. The cleaning method according to claim 10, further comprising:
drying the flexible hose with a fan or a drying element after the flexible hose exits the cleaning box.

16. The cleaning method according to claim 10, further comprising:
reading information regarding the flexible hose from an RFID tag disposed on the flexible hose.

17. The cleaning method according to claim 10,
wherein the passing the flexible hose through the cleaning box comprises spraying cleaning water onto the flexible hose within the cleaning box.

18. The cleaning method according to claim 10,
wherein the passing the flexible hose through the cleaning box comprises passing the flexible hose through a cleaning water pool.

19. The cleaning method according to claim 10,
wherein the passing the flexible hose through the cleaning box comprises passing the flexible hose through a brush cylinder having brushes disposed on an inside circumference thereof.

20. The cleaning method according to claim 10, further comprising:
pressurizing an inside of the flexible hose to check for air leaks.
